(19) United States
(12) Patent Application Publication
(10) Pub. No.: US 2024/0010851 A1
(43) Pub. Date: Jan. 11, 2024

(54) CONDUCTIVE FILM PRECURSOR COATING SOLUTION, METHOD FOR PREPARING SUCH A SOLUTION AND METHOD FOR PREPARING A COATED SUPPORT FOR A CONDUCTIVE FILM

(71) Applicant: MCVE TECHNOLOGIE, SANRY-LES-VIGY (FR)

(72) Inventors: Laura MAZZARA, SORBEY (FR); Raphaël VUILLAUME, METZ (FR); Claude LABRO, TOULOUSE (FR); Christian WEISSE, SANRY-LES-VIGY (FR)

(21) Appl. No.: 18/254,499

(22) PCT Filed: Dec. 20, 2021
(86) PCT No.: PCT/EP2021/086870

§ 371 Date: May 25, 2023

(30) Foreign Application Priority Data
Dec. 23, 2020 (FR) FR2014037

(51) Int. Cl. C09D 5/24; C09D 175/04; C09D 7/61; C08K 3/08; B05D 3/06; C08J 7/18

(52) U.S. Cl. CPC C09D 5/24; C09D 175/04; C09D 7/61; C08K 3/08; B05D 3/067; C08J 7/18; C08K 2003/085; C08K 2201/001; C08J 2375/04

(57) ABSTRACT

A conductive film precursor coating solution, includes between 20 and 50% by weight of a polymerizable composition including 60 to 100% by weight of a mixture of protected polyurethane pre-polymers, between 25 and 60% by weight of a metal filler, or a mixture of metal fillers, based on copper, between 7 and 13% by weight of a solvent or a mixture of solvents, and between 0.1 to 13% by weight of an additive or a mixture of additives.

### FIELD OF THE INVENTION

The present invention relates to the field of printed electronics and more particularly to the field of flexible electronics on different supports. It notably pertains to conductive film precursor coating solutions, the method for preparing such solutions, the use of such solutions to form conductive films on solid supports, the corresponding preparation method and the solid supports coated with the conductive films obtained.

### PRIOR ART

Today, more and more electronic devices are present in our daily lives through objects intended for the general public as well as objects for professional use: televisions, smart phones, connected objects, home automation systems, etc. The majority of these devices are based on the printed circuit technology that has been developing for many years.

Printed circuits are generally qualified by their support, their number of conductive layers, by the bonds between these different layers, by the number of stratifications required for their manufacture and also by their rigidity. Historically, the industry has first seized the most rigid supports, with the use of composite boards made of epoxy resins and a fibrous frame, before proposing more flexible supports made of polyimide.

The manufacturing of printed circuits requires, depending on their complexity, multiple steps, which generally correspond to the addition or removal of material by methods which are often likely to use, on a large scale, substances considered as dangerous and polluting for the environment due to their corrosive or toxic nature.

This is particularly the case for flexible supports, the composition of which often requires the use of particularly aggressive methods to form printed circuits on their surface. Beyond the formation of printed circuits, their durability on such supports is relative. Indeed, the successive deformations they undergo or the friction to which they are exposed, given their use, generally lead to a rapid degradation of their integrity as well as their properties. The environmental impact of this sector is therefore particularly significant and manifests itself both during the manufacturing of printed circuits and also in their limited life span.

In printed circuits, the supports constitute the insulating part in the assembly that represents the circuit, the electrical conductivity of the printed circuit, an essential element, is ensured by the tracks obtained by metallizing the surface of the supports. This step is therefore decisive when it is wished to take into account the environmental impact of the production of printed circuits.

The preparation of conductive films on solid supports has developed in recent years and has led to the multiplication of technical proposals to respond to the problems highlighted in order to obtain conductive films of satisfactory quality on supports of variable nature.

The U.S. Pat. No. 10,154,585 thus describes a method for preparing metal films on polyimide based supports in several steps. The method described notably comprises a first step of treating the surface of the polyimide support on which it is desired to form a metal film, an additional step of applying a paste containing a metal powder as well as a step of heating using a vapor flow. This final step makes it possible to form the metal film.

The metal paste used comprises metal particles, a binder as well as a solvent in which the binder and the particles are dispersed. A wide variety of particles is described, it is notably recommended to use silver particles, notably of lamellar shape generally referred to as flakes, copper and silver coated copper. It is not recommended to use oxidized copper particles due to the reduction in conductivity they would bring to the metal film. In order to obtain particles that meet the expected qualities, it is recommended to prepare them by wet means, which makes it possible to obtain nanoparticles, by electrolytic means from copper salts, by atomization of metallic copper or even by vapor phase decomposition of copper salts or complexes, notably to form nanoparticles.

The method and the paste, which seem so efficient, comprise however significant limits:
The method: the use thereof is restricted to polyimide supports, its implementation involves a pretreatment of the surface of the support, which involves resorting to often corrosive and polluting chemical compounds, before the application of a metal paste, and it further requires the use of a vapor flow which induces a risk of accident in the context of production on an industrial scale.
The metal paste: it comprises metallic particles which must meet specific specifications related to the vapor treatment step that is used, therefore they must have a high electrical conductivity and have a low degree of oxidation, which requires to produce them resorting to methods whose implementation is complex and not very suited to industrial scale production.

The present invention notably aims to meet the challenges currently faced in the field of electronics: to offer solutions that can be used on an industrial scale under mild and environmentally friendly conditions and also to benefit from readily available materials, without complex method, which do not require difficult storage conditions to implement.

It may also be easily taken advantage of in production lines already in place and can be used with the fastest and simplest manufacturing techniques to implement in the field of printed circuits such as additive manufacturing, screen printing and 3D printing, on any type of support, whatever its shape and its nature. Furthermore, it makes it possible to obtain printed circuits and conductive films of which the quality, the conductivity and service life are considerably improved.

### SUMMARY

The present invention relates to a conductive film precursor coating solution characterized in that it comprises a polymerizable composition comprising between 60 and 100% by weight of a mixture of protected polyurethane prepolymers, a metal filler, or a mixture of metal fillers, based on copper, a solvent or a mixture of solvents, an additive or a mixture of additives. It also concerns the method for preparing the solution as well as that of preparing a conductive film on the surface of a solid support with the coating solution.

### Definitions

In the present invention, the terms below are defined as follows:

“Conductive film” or “conductive thin film” or “conductive coating” or “conductive polymer matrix” refers to matrices that conduct electricity of low thickness generally used in the electronics industry and microelectronics as a surface coating for solid supports and in order to confer thereon electrical properties.

“Low thickness” refers to a thickness of several tenths of micrometers to several thousands of micrometers.

“Solid support” refers to supports of variable nature, composition and flexibility on which it is intended to confer electrical properties.

“Coating solution” refers to liquid solutions used to coat solid supports in order to confer thereon particular properties.

“Polymerizable composition” refers to compositions containing prepolymers.

“Prepolymer” or “pre-polymer” refers to macromolecules or molecules of oligomer capable of entering, via reactive groups, into an additional polymerization, thus contributing with more than one constitutional unit to at least one type of chain of the final macromolecules.

“Oligomer” refers to molecules of intermediate relative molecular weight, the structure of which essentially comprises a small plurality of units derived, either genuinely or conceptually, from molecules of lower relative molecular weight.

“Macromolecule” refers to molecules with a high relative molecular weight, the structure of which essentially comprises the multiple repetition of units derived, genuinely or conceptually, from molecules with a low relative molecular weight.

“Metal filler” refers to elements of a metallic nature which, integrated in a coating solution, will be able to provide a particular electrical conductivity to the polymer matrices obtained from this precursor, optionally after a specific treatment.

“Solvent” refers to the different compounds used in the coating solutions in order to ensure their liquid state under the conditions of use for coating purposes.

“Additive” refers to elements which, integrated into a coating solution or conductive film, confer thereon particular physical properties of a non-essentially electrical nature.

“Printed circuit” refer to supports making it possible to maintain and to electrically connect a set of electronic components together, with the aim of producing a complex electronic circuit.

“Printed circuit conductive tracks” refers to metallic patterns intended to conduct electricity within printed circuits.

### DETAILED DESCRIPTION

The present invention relates to a conductive film precursor coating solution characterized in that it comprises:
Between 20 and 50% by weight of a polymerizable composition comprising 60 to 100% by weight of a mixture of protected polyurethane pre-polymers,
Between 25 and 60% by weight of a metal filler, or a mixture of metal fillers, based on copper,
Between 7 and 13% by weight of a solvent or a mixture of solvents,
Between 0.1 and 13% by weight of an additive or a mixture of additives.

The polymerizable composition comprises mainly a mixture of protected polyurethane pre-polymers, in proportions of 60 to 100% by weight, and may contain between 0 and 40% by weight of a resin or a resin mixture selected from the group comprising a thermoplastic polyimide resin, a polyamideimide resin, a polyphenylene sulfide resin, a polyvinyl chloride resin, a styrol resin, a polyisocyanate resin, unprotected polyurethane pre-polymers.

The polymerizable composition may notably comprise 70% of a hydroxylated polymer and 30% of a protected polyisocyanate resin, or 80% of a hydroxylated polymer and 20% of a protected polyisocyanate resin.

Preferably, the precursor coating solution of conductive films comprises between 25 and 35% of polymerizable composition.

The polyurethane pre-polymers correspond to molecules that are able to react with each other by polyaddition reaction to lead to polyurethanes. These are generally hydroxylated products, i.e. having one or more primary —OH reactive groups such as diols, triols or sucroses (sorbitols, etc.), and products comprising one or more isocyanate groups.

To form a polyurethane polymer, a mixture of pre-polymers, in determined proportions, capable of reacting with each other to form the polyurethane polymer, is generally prepared. This type of product is commercially available and sold in the form of a kit that needs to be mixed.

For the purposes of the invention, the protected polyurethane pre-polymers correspond to polyurethane pre-polymer compositions whose functional groups, in particular isocyanate groups, have been protected using a protective group and which, except to be used under particular conditions, will not initiate a polymerization reaction and will have comparatively greater stability under normal storage conditions than the unprotected polyurethane pre-polymer.

The isocyanate group having a greater reactivity than that of the hydroxyl group, it is the isocyanate group that is usually protected. Thus, among the functional groups and products that may be used to protect the polyurethane prepolymers, mention may be made notably of the groups: alcohol (e.g. butanol, ethanol, isopropanol, phenol, ortho cresol), thiol (e.g. thiophenol, mercaptan), dicarboxylated compounds (e.g. diethyl malonate), oxime, amide (e.g. acetanilide, methylacetamide), cyclic amide (e.g. pyrrolidinone, caprolactam), imide (e.g. succinimide, hydroxyphthalimide), imidazole, pyrazole (e.g. dimethylpyrazole), triazole (e.g. benzotriazole, triazole), amidine, etc. which each lead to the formation of a protective group by reacting with the reactive group.

The protective group used is chosen according to the de-protection conditions that it is wished to implement subsequently. The de-protection can notably be done chemically, thermally or by irradiation.

A thermal de-protection is preferably used. Thus, thermolabile protective groups are preferred, in fact, their elimination consists simply in increasing the temperature of the coating solution containing them, which leads to the deprotection of the protected sensitive part and to regenerating the reactive groups likely to polymerize.

For the purposes of the invention, the mixture of protected polyurethane pre-polymers has a recommended molecular weight of between 500 and 10,000 g/mol, preferably 500 and 5,000 g/mol.

The mixture of protected polyurethane pre-polymers may comprise predominantly protected toluene diisocyanate (TDI), protected 1,6-diisocyanatohexane or hexamethylene diisocyanate (HDI), protected 4,4′-diphenylmethane diisocyanate (MDI) or isophorone diisocyanate (IPDI).

For the purposes of the invention, a copper-based metal filler corresponds to a mixture comprising mainly, and advantageously only, copper particles. This type of mixture is generally prepared from commercially available metal powder.

The particles preferably have a median size of between 1 and 20 μm in diameter. Their shape is variable, it may notably be substantially spherical or flat, advantageously it has a lamellar shape.

The copper particles used may be partially oxidized, advantageously they are completely oxidized. The mixture may contain variable proportions of non-oxidized, partially oxidized and fully oxidized particles, it preferably contains a majority of oxidized and partially oxidized particles, and advantageously a majority of partially oxidized particles, more advantageously only partially oxidized particles.

According to a preferred embodiment, the partially oxidized particles are oxidized on the surface and comprise a non-oxidized core.

Advantageously, the conductivity of the metal filler or the mixture of fillers, measured on the metal powder(s) to prepare the coating solution, is between 0 and 10⁻⁸ S·m⁻¹.

The solvent or mixture of solvents used in the invention is chosen such that the coating solution is liquid under the conditions of use for coating purposes.

The solvent may be of an organic nature, it could notably be aromatic or aliphatic hydrocarbons, ether, ester, ketone.

The solvent may be protic, i.e. it comprises at least one hydrogen atom capable of being released in proton form. The protic solvent is advantageously selected from the group consisting of water, deionized water, distilled water, acidified or not, acetic acid, hydroxylated solvents such as short carbon chain alcohols, notably methanol and ethanol, glycol derivatives, such as acetates and ethers, liquid glycols of low molecular weight such as ethylene glycol, and mixtures thereof.

According to a first alternative of the invention, an organic solvent or a mixture of organic solvent, notably xylene, is used.

According to another alternative of the invention, a solvent mixture that comprises at least one protic solvent, notably water, is used.

Typically, a solvent mixture comprising xylene and/or ethylbenzene is used in proportions varying between 7 and 13% by weight of the coating solution.

Among the additives usable in the context of the invention, mention may notably be made of wetting agents, fluidizing agents, emulsifiers, pigments, surfactants, plasticizers, stabilizers, rheological agents, dispersants, polymerization catalysts, drying substances.

Advantageously, at least one additive of wetting agent type or at least one additive of rheological agent type is used.

The amount of additive or mixture of additive present in the coating solution represents between 0.1 and 13% by weight, advantageously the amount is greater than 0.5% and less than 7%.

The solution has, typically after preparation, a viscosity of between 500 and 20,000 cps, preferably between 2,000 and 8,000 cps. The viscosity of the solution may be adapted beforehand, notably by adding solvent, to the coating method that it is wished to implement and for example by spread coating, by spraying, by sheet-to-sheet or continuous screen printing (roll-to-roll).

The coating solution may be applied to the surface of solid supports of varied nature, size and shape. The surface may be of an organic and/or nonorganic nature, and may also be of a composite nature, it may have significant spatial structuring on different scales.

The solid support may have an inorganic surface that can be chosen from non-conductive materials such as SiO₂, Al₂O₃ and MgO. More generally, the inorganic surface of the solid support may consist of, for example, an amorphous material, such as a glass generally containing silicates or a ceramic, as well as crystalline.

The solid support may have an organic surface. As the organic surface, mention may be made of natural polymers such as latex or rubber, or artificial polymers such as polyimide or polyamide or polyethylene derivatives, and notably polymers having type n bonds such as polymers bearing ethylenic bonds, carbonyl groups, notably polyaryletherketone, in particular polyetherketone (generally known as PEK) or polyetheretherketone (generally known as PEEK), imine. It is also possible to apply the method to more complex organic surfaces such as surfaces comprising polysaccharides, such as cellulose for wood or paper, artificial or natural fibers, such as cotton or felt.

The solid support may be composed of an assembly of solid supports of smaller size that are assembled and maintained together due to mechanical stresses. According to a particular embodiment, the solid support is constituted of an assembly of natural fibers, such as linen, hemp or cotton, or artificial fibers such as glass or carbon fibers.

Preferably the surface of the solid support to which the coating solution is applied is electrically insulating, in particular with an electrical conductivity of between 0 and 10⁻⁸ S·m⁻¹, it may in particular be a surface composed of polymers such as polyimides, PEK or PEEK.

The coating solution is advantageously used on solid supports whose size scale varies in a first dimension from several millimeters to several hundred millimeters and in the other two dimensions up to several meters, and whose surface can extend on the same scales. These are typically solid supports such as rigid plastics.

The coating solution is advantageously used on solid supports whose size scale ranges in a first dimension from several microns to several hundred microns and in the other two dimensions from several millimeters to several hundred meters, and whose surface area can extend on the same scales. These are typically solid supports such as flexible plastics.

Depending on the method used, it can thus notably be applied to objects such as polycarbonate.

The present invention also relates to the method for preparing the coating solutions described above.

The preparation can be done by mixing in the solvent polyurethane pre-polymers with the additives used and then adding metal fillers.

The invention also relates to a method for preparing a conductive film precursor film on a solid support which comprises the following steps:
1) Depositing a conductive film precursor coating solution, as previously described, on one or more areas of the surface of said support,
2) De-protection of the mixture of protected polyurethane pre-polymers present in the polymerizable composition and polymerization.

The invention also relates to a method for preparing a conductive film on a solid support which comprises the following steps:
1) Depositing a conductive film precursor coating solution, as previously described, on one or more areas of the surface of said support,
2) De-protection of the mixture of protected polyurethane pre-polymers present in the polymerizable composition and polymerization,
3) Application of a reducing treatment, capable of reducing the copper oxide present in the coating solution, to the coated areas from which it is wished to form a conductive film, and/or deposition of a metallic layer by chemical and/or electrochemical means to the coated areas from which it is wished to form a conductive film.

Optionally, the method also comprises a step of extracting the solvent from the coating solution. This step can notably be achieved by air circulation, heating or evaporation. It is advantageously performed in such a way that no significant amount of solvent remains and/or that the amount of solvent present at the end of the method in the conductive film is stable under the conditions of use of the coated support.

During the deposition step, the solution can be applied or spread coated on the surface of the solid support according to the different methods well known to those skilled in the art, notably by dipping (immersion-emersion), centrifugation (spin coater), sprinkling or spraying (spray), projection (inkjet, spray gun), screen printing (stencils, squeegees and perforated rollers acting as physical masks), transfer or painting (brush, roller, roller to roller, felt brush, pad, heliogravure, engraving blocks (flexography), impregnation, sizing. Other contact and non-contact application methods can be used.

Advantageously, the thickness of the coating solution layer that is deposited is between 0.1 and 500 μm and preferably between 5 and 200 μm.

According to a particular embodiment, the area(s) on the surface of the support on which the coating solution is deposited form a pattern that is predetermined. Advantageously, the deposition is then carried out by a controlled proportioner or dispenser method or uses a physical mask, for example in the case of dipping or roller to roller, to define all or part of the pattern.

According to a particular embodiment, step 2 and the solvent extraction step are performed simultaneously.

According to another preferred embodiment, the method comprises a treatment step of crosslinking the polymerizable composition, which can for example be implemented using UV-visible (100 to 780 nm), or near-infrared radiation (about 780 to 2,500 nm), by using a thermal oven or a hot air flow. The duration of this crosslinking is generally between 1 and 30 minutes and preferably between 10 and 20 minutes. Advantageously, the crosslinking step corresponds to step 2 and that of solvent extraction.

According to another preferred embodiment, the method comprises an irradiation step at a wavelength of between 100 and 2,500 nm. The duration of the irradiation is generally between 0.1 and 50 μs for ultraviolet radiation and between 1 and 5 min for infrared radiation. Advantageously, the irradiation step takes place in step 2 and the solvent extraction step.

The reducing treatment generally corresponds to a treatment by photonic, thermal or chemical means. According to a particular embodiment, the reducing treatment corresponds to a chemical reduction in the presence of a reducing agent such as formaldehyde, hypophosphite, hydrazine or glucose.

The conductive films obtained by applying the method implementing a reducing treatment typically have a conductivity of between 1.1·10⁵ and 1·10⁶ S·m⁻¹.

The conductive films obtained by applying the method implementing the deposition of a metallic layer, such as nickel or copper, typically have a conductivity of between 1.1·10⁶ and 1·10⁷ S·m⁻¹ in the case of chemical copper and 1.1·10⁷ to 1.10⁸ S·m⁻¹ in the case of electrochemical copper.

According to a specific embodiment, the method comprises a step of thermoforming the solid support. Thermoforming is a technique that consists of using a solid support, preferably in a flat form, heating it to soften it, and taking advantage of this ductility to shape it with a mold. The material hardens as it cools, keeping this shape. Advantageously, the thermoforming step is performed after an irradiation step.

The conductive film precursor films and the conductive films obtained by applying the method typically have a value of 0 in the cross-cut adhesion test according to the ISO2409 standard.

The invention also pertains to:
The solid supports obtained with one of the methods mentioned above,
The conductive film precursor films on solid support, obtained using any one of the methods mentioned above,
The conductive films on solid support, obtained using any one of the methods mentioned above,
The use of solid supports coated with a conductive film precursor film, or a conductive film, obtained using any one of the methods mentioned above, for the purposes of preparing electronic circuits and conductive tracks, heating tracks, sensors, passive components, antennas, in particular RFID, UHF, NFC, Bluetooth and 5G applications, as well as for the purposes of electromagnetic shielding.

The invention is easily usable on an industrial scale and can notably be used in the field of rigid electronics to make conventional printed circuits, in the field of flexible electronics to make printed circuits on flexible supports such as polyethylene (PE), polyethylene terephthalate (PET), polyethylene naphthalate (PEN), polyimide (PI), polyphenylene ether (PPE), PEK, PEEK, polycarbonate (PC), synthetic and other papers for simplified manufacturing, e.g. by a roll-to-roll printing method, radio frequency antennas, actuators and detectors, to prepare electromagnetic shielding areas, heating tracks on complex shaped objects, e.g. by spread coating, in the field of multifunctional composite materials.

The invention may also be used in the automotive field as a means of electrical connection to eliminate wiring in vehicles.

The invention has many advantages and for different aspects compared to the prior art, among them:
The conductive film precursor coating solutions according to the invention have a particularly long lifetime under simple storage conditions thanks to the presence of protective groups; they do not require the preparation of mixtures during their use and are directly applicable on solid supports;
The invention allows the use of commercial metal powders as such, which are generally oxidized, and for which it is not necessary to implement an additional preparation step such as grinding or laser activation;
The conductive film precursor coating solutions can be used on solid supports of variable shapes and volumes, and more generally on three-dimensional solid supports;
The preparation of a conductive film precursor film on the surface of a solid support can be performed by deposition and simple UV or IR heating or irradiation;
The methods used for the metallization of plastics notably make it possible to directly fix a metal layer and do not require the use of palladium type catalysts;
The methods also make it possible to deposit conductive films of varied topographies without the use of masks, in particular on supports constituted of plastic;
The solid supports coated with conductive film precursor films or conductive films may be thermoformed;
The supports obtained by the method according to the invention do not require a preliminary surface treatment step for their use;
The conductive films that are obtained thanks to the invention have remarkable properties such as superior adhesion and excellent conductivity;
The conductivity of the conductive films obtained is easily adjustable thanks to the material used and the control provided by the invention on the thickness of the conductive film;
The invention can be used in the additive technologies sector;
The solid supports obtained by the methods of the invention are recyclable after the removal of the conductive films or conductive film precursor films.

### BRIEF DESCRIPTION OF THE FIGURES

FIG. 1 is a representation of a view of the surface of a solid support (1) coated with a conductive film (2) according to the invention; the conductive film was prepared to form meanders on the surface.

FIG. 2 is a representation of the cross-sectional view, along the axis A-A, of the surface of a solid support (1) coated with a conductive film (2) according to the invention.

FIG. 3 represents a surface temperature curve (° C.) obtained from a glass textile fiber support (60×130 mm) coated with a conductive film forming meanders on its surface (FIG. 1) to which a direct current is applied (1A per track under 3V); the measurement was made along the axis represented by A-A in FIG. 2, the edge-to-edge distance (d) is expressed in mm.

FIG. 4 is an exploded view representation of a PZE (for PieZoElectric) sensor made on a solid support (1) comprising two layers of electrodes 41, 43 at least one of which is made by forming a conductive film according to the invention and a layer of piezoelectric printed ink 42 between these two layers of electrodes 41, 43.

### EXAMPLES

The present invention will be better understood on reading the following examples that illustrate the invention in a non-limiting manner.

### Example 1: Preparation of a Coating Solution

Different coating solutions were prepared by first mixing at room temperature in the solvent a polymerizable composition comprising protected polyurethane pre-polymers, as well as optional resins, with the additives used and then by adding metal fillers. The different solutions are as follows:

### Solution A:

Polymerizable composition (50%) comprising a mixture of protected polyurethane prepolymer (20% polyisocyanate and 80% hydroxylated polymer),
Copper powder: microparticles of size smaller than 15 μm (30%),
Solvent: xylene (15%),
Additives (5%).

### Solution B:

Polymerizable composition (30%) comprising a mixture of protected polyurethane prepolymer (30% polyisocyanate and 70% hydroxylated polymer),
Copper powder: microparticles of size smaller than 15 μm (47%),
Solvent: mixture of xylene and ethylbenzene (10%),
Additives (13%).

### Example 2: Deposition of the Solution on Support and Preparation of Films

### Example 2.1: Conductive Film Precursor Films

The solutions obtained according to Example 1 were deposited on the surface of varied supports, of variable size, using three different deposition methods: dispenser, screen printing and spraying.

Solid Supports Used:
S1: Composite material is made of ⅔ mineral fillers and ⅓ acrylic resin such as the composite material known under the trade name Corian®,
S2: Thermoplastic polyamide such as PA 6, PA 6.6, PA 11, PA 12, or nylon.
S3: Material of the polyethylene family, such as a polyethylene terephthalate (or PET) or a polyethylene polynaphthalate (or PEN),
S4: Polybutylene terephthalate,
S5: Polycarbonate e.g. Makrolon®,
S6: Acrylonitrilebutadiene styrene or ABS,
S7: Epoxide or epoxy glass cloth FR-4,
S8: Polyimide, for example Kapton®,
S9: Nylon resin,
S10: Fiberglass,
S11: Material of the polypropylene family, for example polyphenylene ether (or PPE) or polyphenylene sulfide (or PPS).
S12: Polyphenylene ether (or PPE), polyphenylene sulfide (or PPS).

### Example 2.2: Obtaining Conductive Films by Reducing Treatment

The solid supports obtained in Example 2.1 were then subjected to a reducing treatment according to the following protocol: the coated support was immersed in a copper reducing solution containing a reducing agent (formaldehyde, hypophosphite, hydrazine or glucose).

Said coating has a conductivity of between 1.1·10⁵ and 1·10⁶ S·m⁻¹ depending on the treatment time applied.

### Example 2.3: Obtaining Conductive Films by Deposition of a Metallic Layer by Chemical and/or Electrochemical Means

After deposition on a defined substrate, the coating solution was then subjected to a chemical and/or electrochemical copper deposition. For example, a chemical copper deposition of 1 μm is obtained after 20 min immersion in a chemical reduction bath. The thickness of the electrochemical copper deposition is controlled by the experimental parameters controlling the electrochemical bath (temperature, current density, stirring, etc.).

The treatment was applied until, in some cases, a film thickness of between 20 and 40 μm was obtained. Conductivities up to 1·10⁸ S·m⁻¹ were obtained.

### Example 3: Qualification of Conductive Films

### Example 3.1: Adhesion Test

The films present on the supports obtained at the end of example 2 were subjected to the cross-cut adhesion test as per the ISO2409 standard: this test makes it possible to qualify the mechanical behavior of a coating on a support.

The films were cross-cut at right angles until they reached the support to form a cross-cutting. The level of adhesion of each film was assessed by comparison with standardized reference images representing the degree of degradation.

A value of 0 was obtained for the different films, this value corresponds, according to the standard applied, to films fully adhered to their supports.

### Example 3.2: Ampacity Test and Comparison

The electrical performance of the films present on the supports obtained from example 2 was determined according to the IPC-2221 (Generic Standard for Printed Board Design) which involves ampacity measurements or the ability to carry electrical current. The reference support is an FR-4 board (abbreviation for Flame Resistant 4), a material commonly used for the manufacture of printed circuits made of glass fiber reinforced epoxy resin composite material.

Examples of results obtained on polybutylene terephthalate supports treated according to example 2.3 are shown in Table 1.

TABLE 1

| | Reference support | | | Measurement | | |
|---|---|---|---|---|---|---|
| Thickness | AT | AT | AT | AR | AR | AR |
| (μm) | Track 7 | Track 8 | Track 9 | Track 7 | Track 8 | Track 9 |
| 45 | 2.51 | 1.95 | 1.62 | 1.86 | 1.50 | 1.42 |
| 41 | 2.20 | 1.81 | 1.67 | 1.57 | 1.52 | 1.6 |

The “thickness” column specifies the thickness of the conductive film that has been prepared.

The ampacity measurements (in amperes) made (AR) on the coating solution comprising an additional layer of chemical and electrochemical copper show that this combination makes it possible to achieve ampacity values close to the theoretical values (AT). Indeed, the ampacity obtained is between 65 and 85% of the ampacity of laminated copper, this being for a temperature elevation of 10° C.

### Example 3.3: Heat Dissipation Test and Comparison

The heat dissipation of the films present on the supports obtained at the end of example 2 (2.3) was determined by depositing the supports on two substrates with a thermal conductivity of 2 and 3 W/m·K respectively and applying a voltage of 10 V and a limit intensity of 50 mA for 20 min.

It turns out that the heat induced by the temperature rise related to the continuous operation of the system can be dissipated through the material.

The results show a heat dissipation gain of 60-80% depending on the support compared to a conventional circuit on FR-4 substrate.

### Example 4: Applications for Heating Surfaces

Heating resistive tracks (as per example 2.3) were made directly on the surface of flexible supports or conversely on rigid supports with a thickness of 12 mm.

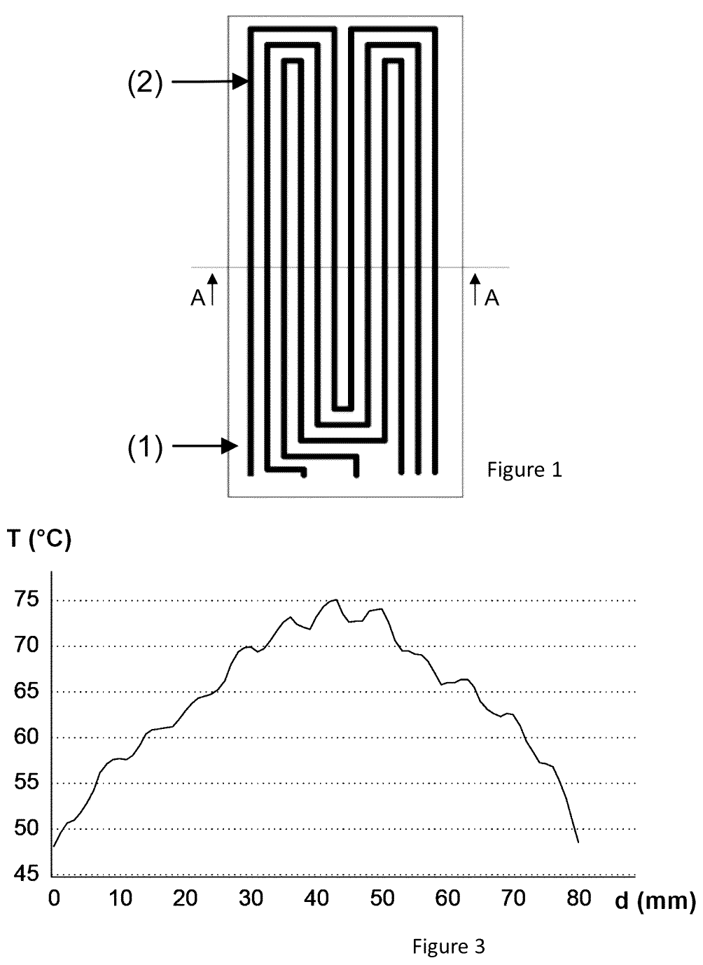

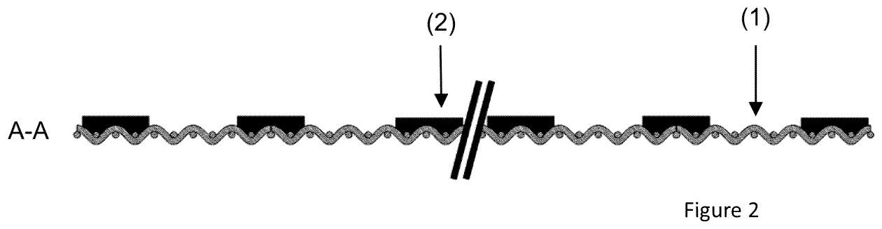

The coating solution was deposited using a numerically controlled pneumatic dispenser to form meanders, as illustrated in FIG. 1 and FIG. 2, of electrical tracks (2) over the entire surface to be functionalized (1).

Whatever the solid support used, the controlled application of a conductive copper film by chemical means allowed a favorable resistivity to be obtained to release heat by joule effect with very low voltages. Indeed, a surface temperature of 75° C. was reached with a voltage below 12 V (direct current) on a 60×130 mm glass textile substrate, as illustrated in FIG. 3 which presents a temperature measurement curve by IR camera. The heat density obtained on this construction reaches 780 W/m². The support and metal deposition have a total thickness of 600 μm and tolerate bending around a radius of 5 mm.

Other devices integrating the heating coated supports have also been produced. Thus, a 12 mm thick Corian® board using this same manufacturing technique and integrating several functions was prepared:
12 W heating tracks,
Printed capacitive touch buttons,
SPI (Serial Peripheral Interface) data bus to transmit the information of a temperature probe,
Tin/lead soldering of electronic components known as SMCs (resistance, sensor), (SMC: surface mount component).

The conductivity levels of the multilayer material were modulated using different coating solutions including or not metal layers and variable thicknesses.

The resistivity given to the conductive film has here made it possible to avoid an over dimensioning of the electrical power supply compared to the use of a traditional printed circuit, which necessitates much higher currents to generate the same heat.

Unlike what it is possible to do with conductive films based on silver, it was possible to apply conventional soldering on different supports.

### Example 5: Application for Electromagnetic Shielding

The coating solution allows adhesion on many plastic substrates, it has been tested for the construction of lightweight electromagnetic shielding materials.

The plastic supports coated with conductive film precursor films (example 2.1) have benefited from a metallic deposition by chemical/electrochemical means according to the protocol of example 2.3. Among the metals that have been deposited: Cu, Ni, NiCu, NiFe, NiFeMo (permalloy), mu-metal, supermalloy.

Tests performed on the coating solution with a copper metal reinforcement whatever its thickness showed 70 dB attenuation for frequencies between 0.5 and 3 GHz.

### Example 6: Application for PZE Sensors

The coating solution makes it possible to produce PZE sensors. PZE sensors (also known as “piezoelectric sensors”) can be particularly advantageous on solid supports for the manufacture of hybrid material structures, for example for the manufacture of tanks or body parts for measuring and recording the pressures experienced by said structure. PZE sensors allow the detection of elastic deformation of a surface thanks to the piezoelectric properties of this type of sensor.

“Hybrid materials” is taken to mean a composite material, preferentially a material comprising at least one organic material and one inorganic material. The hybrid material may comprise a resin, fibers, and/or a honeycomb structure.

The inorganic material may be chosen from non-conductive materials such as SiO₂, Al₂O₃ and MgO. More generally, the inorganic material may be chosen from amorphous materials, such as glass generally containing silicates or even ceramics, as well as crystalline materials.

These PZE sensors make it possible to monitor the state of a structure, to detect and predict their failure. PZE sensors can thus ensure the safety and reliability of composite structures by implementing an array of piezoelectric sensors integrated into the composite structure to analyze deformation as well as vibration wave echoes and electromechanical impedance variation.

Generally, to produce such a PZE sensor on a wall, it is necessary to add a PET sheet making it possible to serve as support. Unlike existing walls comprising pressure sensors, no additional layer was required to integrate the pressure sensors. This results in walls provided with PZE sensors whose dimensions, mass and mechanical properties have been preserved.

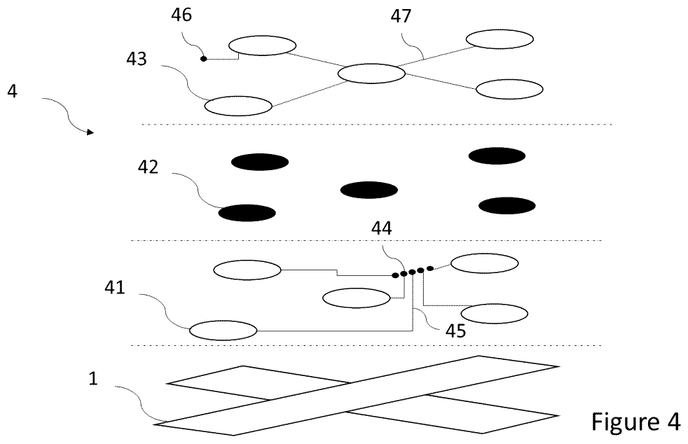

An exploded view of such a sensor 4 is illustrated in FIG. 4. Said sensor 4 comprises a solid support 1. Said solid support 1 may comprise a layer of a wall of which it is wished to measure the pressures and/or deformation stresses. For example, it may be a layer of a composite structure of a tank wall, an aeronautical part wall, an automotive body layer.

The solid support 1 comprises a first array of metal electrodes 41 produced by the method according to the invention. The first array of electrodes comprises a plurality of electrodes and each electrode is connected to a conductive terminal 44 by a connection track 45. The first array of electrodes is preferably produced by formation of a conductive film on the solid support 1 by the method according to the invention. The electrodes of the first array of electrodes are preferentially electrically isolated from each other.

The sensor 4 further comprises a plurality of piezoelectric cells 42, preferentially piezoelectric polymers. These piezoelectric polymer cells 42 are preferentially deposited by printing. Each cell 42 is applied to an electrode of the first electrode array 41. Each piezoelectric cell is insulated from each other. A connection mode in series may also be used.

In one embodiment, the dimensions of the piezoelectric cell are greater than the dimensions of the electrode on which it is arranged. Preferentially, the piezoelectric cell is arranged on an electrode so as to completely cover the surface of said electrode.

The sensor 4 finally comprises a second array of electrodes 43. Each electrode of the second electrode array is arranged above each piezoelectric cell in such a way as to create a sandwich structure in which the piezoelectric cell is between an electrode 41 of the first array and an electrode 43 of the second array.

In one embodiment, the second electrode array comprises metal electrodes produced by the formation of a conductive film on a second solid support (not represented) by the deposition method according to the invention. The second solid support may be a temporary solid support that will not be kept in the final structure. In one embodiment, the second electrode array comprises metal electrodes produced on each piezoelectric cell by the method of formation of a conductive film according to the invention on each piezoelectric cell. In another alternative embodiment, the second array of electrodes may be formed by any other method known to those skilled in the art. For example, the assembly of the second array of electrodes can be performed by conductive film adhesive techniques.

In one embodiment illustrated in FIG. 4, the electrodes of the second electrode array 43 are electrically connected to each other in series by connection tracks 47 and are connected in series to a connection terminal 46. In an alternative embodiment, not represented, the electrodes of the second array of electrodes are electrically isolated from each other to be individually connected to a multiple conductive terminal in a similar manner to the electrodes of the first array of electrodes 41.

The connection terminals 44 of the first array of electrodes are preferentially electrically connected to a device for measuring intensity, load and/or electrical voltage, for example via a flexible cable.

Said measuring device, also connected to the second array of electrodes, thus makes it possible to measure the properties of the current generated by each piezoelectric cell.

The piezoelectric cell makes it possible to generate a current when it is mechanically deformed. Therefore, a deformation stress of the wall at the level of the sensor will be detected and localized by the measuring device.

The piezoelectric cell preferentially comprises a piezoelectric polymer, the advantage of which is that it is light and easy to print on the first array of electrodes. The piezoelectric polymer may comprise polyvinylidenefluoride (PVDF). PVDF is a semi-crystalline, viscoelastic piezoelectric material.

Preferentially, the PDVF used is a crystalline PDVF known as beta. The advantage of this crystallinity is a better piezoelectric effect of the polymer. Indeed, in this crystalline structure, all the dipoles of the polymer are aligned in the same direction. This crystalline structure can therefore generate the greatest spontaneous polarization and has important ferroelectric and piezoelectric properties.

In a preferential embodiment, the PVDF copolymer with trifluoroethylene (TrFE) is used. Such a poly(vinyldenefluoride-co-trifluoroethylene (P(VDFTrFE)) copolymer has crystallinity with better polarity and temperature stability than traditional PVDFs as well as better piezoelectric properties.

Any other type of compound with sufficient piezoelectric properties may also be used, for example in the form of ink, notably certain inks or materials comprising BaTiO₃.

Such a sensor 4 advantageously makes it possible to be mounted in composite structures without the need to add additional support layers for the electrodes or the piezoelectric cell and makes it possible to measure the mechanical performance of the composite structure. Such a sensor may advantageously be used to detect the mechanical loadings suffered by materials on aircraft structures. Such a structure may also be used as a strain gage, shock sensor, vibration sensor or deformation sensor. For example, such a sensor is particularly advantageous in wind blades to determine material fatigue. In another embodiment, such a sensor may be implemented or integrated into a person presence and position detection system, for example when such sensors are integrated into a ground slab or floor slab.

PZE sensors can be used in energy recovery. Indeed, PZE sensors can recover the energy available in the structural environment from vibrations, thermal gradients or solar radiation and transform it into storable electrical energy. Preferentially, said structure may comprise means of energy conservation and is designed to supply said means of energy conservation by the electrical energy generated by a PZE sensor during its deformation.

In one embodiment, such a structure may also be used in the opposite sense. A current can be applied to the piezoelectric cells to cause a change in the dimensions of the piezoelectric cells. Advantageously, a structure may comprise a combination of described cells, some used as sensors, and others used to cause a change in cell dimensions by applying a current. This combined mode advantageously makes it possible to detect a pressure and automatically generate a response from a nearby cell to at least partially counteract this pressure.

In one embodiment, such a structure may comprise a plurality of piezoelectric cells mounted as sensor and at least one piezoelectric cell mounted as actuator.

One advantage is to generate a vibration in the structure with the piezoelectric cell mounted as an actuator. The vibration is then measured by each piezoelectric sensor. The vibration profile measured by each sensor can be used to locate defects in the structure, for example delamination defects. Indeed, vibrations propagate differently in such a defect. Consequently, by mapping the sensor measurements, it is possible to estimate the location of such a fault.

### Example 7: Application for Radio Frequency Antennas

Conductive film tracks (as per example 2.3) were produced directly on the surface of flexible supports or, conversely, on rigid supports so as to create a spiral for producing an NFC (for “Near Field Communication”) antenna.

In one example, an antenna formed by conductive film tracks (copper) of a substantially rectangular shape and comprising 5 spirals was produced on a flexible support. At a frequency of 13.557 MHz, the return loss was measured at 1.87 dB.

Antennas produced by formation of conductive film tracks obtained by the method according to the invention may be used for RFID, NFC or UHF (“Ultra High Frequency”) applications.

1. A conductive film precursor coating solution, comprising:
between 20 and 50% by weight of a polymerizable composition comprising 60 to 100% by weight of a mixture of protected polyurethane prepolymers,
between 25 and 60% by weight of a metal filler, or a mixture of metal fillers, based on copper,
between 7 and 13% by weight of a solvent or a mixture of solvents,
between 0.1 to 13% by weight of an additive or a mixture of additives.

2. A conductive film precursor coating solution according to claim 1, wherein the polymerizable composition comprises between 0 and 40% by weight of a resin or a resin mixture selected from the group consisting of a thermoplastic polyimide resin, a polyamideimide resin, a polyphenylene sulfide resin, a polyvinyl chloride resin, a styrol resin, a polyisocyanate resin, and unprotected polyurethane pre-polymers.

3. A conductive film precursor coating solution according to claim 1, wherein the resin mixture of protected polyurethane pre-polymers comprises mainly protected toluene diisocyanate (TDI), protected 1,6-diisocyanatohexane or hexamethylene diisocyanate (HDI), protected 4,4′-diphenylmethane diisocyanate (MDI) or isophorone diisocyanate (IPDI).

4. A conductive film precursor coating solution according to claim 1, wherein the metal filler, or the mixture of metal fillers, based on copper corresponds to a mixture mainly comprising partially or totally oxidized copper particles.

5. A conductive film precursor coating solution according to claim 4, wherein the metal filler, or the mixture of metal fillers, based on copper corresponds to a mixture comprising only partially or totally oxidized copper particles.

6. A method for preparing a conductive film precursor film on a solid support, the method comprising:
depositing a conductive film precursor coating solution, according to claim 1, on one or more areas on the surface of said solid support, and
de-protection of the mixture of protected polyurethane pre-polymers present in the polymerizable composition and polymerization.

7. A method for preparing a conductive film on a solid support the method comprising:
depositing a conductive film precursor coating solution, according to claim 1, on one or more areas on the surface of said support,
de-protection of the mixture of protected polyurethane pre-polymers present in the polymerizable composition and polymerization, and
applying a reducing treatment, capable of reducing the copper oxide present in the coating solution, to the coated areas from which it is wished to form a conductive film, and/or deposition of a metallic layer by chemical and/or electrochemical means to the coated areas from which it is wished to form a conductive film.

8. The method according to claim 6, comprising crosslinking the polymerizable composition implemented using UV-visible radiation in a range from 100 to 780 nm, or near-infrared radiation in a range from 780 to 2,500 nm, by using a thermal oven or a hot air flow.

9. The method according to claim 6, further comprising thermoforming the solid support.

10. A solid support obtained by a method according to claim 6.

11. A composite material comprising a stack of at least two layers and comprising, between said at least two layers, a conductive film obtained by a method according to claim 6.

12. A sensor comprising a solid support comprising a first array of metal electrodes obtained by a method according to claim 6, a second array of metal electrodes, and an array of cells comprising a piezoelectric compound deposited between the metal electrodes of the first and second arrays of electrodes.

13. A heating device comprising a solid support and a metal track produced by forming a conductive film obtained by claim 6; said heating device further comprising connection means to connect an electrical power supply to said metal track.

14. A radiofrequency antenna comprising a solid support; obtained by a method according to claim 6.

15. An electromagnetic shielding structure obtained by a method according to claim 6.

16. A sensor comprising a composite material comprising a first array of metal electrodes obtained by a method according to claim 6, a second array of metal electrodes, and an array of cells comprising a piezoelectric compound deposited between the metal electrodes of the first and second arrays of electrodes.

17. A heating device comprising a composite material and a metal track produced by forming a conductive film obtained by claim 6; said device further comprising connection means to connect an electrical power supply to said metal track.

18. A radiofrequency antenna comprising a composite material; obtained by a method according to claim 6.

19. An electromagnetic shielding structure comprising a solid support according to claim 10.

20. An electromagnetic shielding structure comprising a composite material according to claim 11.
